(19) United States
(12) Patent Application Publication
(10) Pub. No.: US 2024/0093948 A1
(43) Pub. Date: Mar. 21, 2024

(54) THERMAL STORAGE UNIT

(71) Applicant: FLYING DIAMONDS ENERGY COMPANY, LLC, Ann Arbor, MI (US)

(72) Inventor: Brian Oslin, Carmichael, CA (US)

(21) Appl. No.: 18/469,611

(22) Filed: Sep. 19, 2023

Related U.S. Application Data
(60) Provisional application No. 63/407,814, filed on Sep. 19, 2022.

(51) Int. Cl. F28D 20/00; F28D 13/00

(52) U.S. Cl. CPC F28D 20/0056; F28D 13/00; F28D 2020/0013; F28D 2020/0078

(57) ABSTRACT

A thermal storage unit is purposed to convert electrical energy and store the energy in the form of heat in a more efficient and cost-effective way. It may include a chamber having a predetermined amount of solid particulate. A chamber inlet may be in fluid communication with a pressurized fluid gas. A chamber outlet may allow the pressurized fluid gas to exit the chamber. A plenum disposed between the chamber inlet and the chamber outlet may pass the pressurized fluid from the chamber inlet to the solid particulate to form a fluidized bed of the solid particulate in the chamber prior to the pressurized fluid exiting the chamber outlet. A heating element may be thermally coupled to the fluidized bed, where the heating element is configured to convert electrical energy into thermal energy and transfer the thermal energy to the fluidized bed of the solid particulate.

### CROSS-REFERENCE TO RELATED APPLICATIONS

This application claims the benefit of U.S. Provisional Application No. 63/407,814 filed on Sep. 19, 2022. The entire disclosure of the above application is incorporated herein by reference.

### FIELD

The present technology includes processes and articles of manufacture that relate to storing thermal energy, including a thermal storage unit for converting electrical energy to thermal energy for storage in the form of heat.

### INTRODUCTION

This section provides background information related to the present disclosure, which is not necessarily prior art.

There is a continuing need for a thermal storage unit (TSU) that may convert electrical energy to thermal energy for storage in the form of heat. In certain embodiments, a TSU including conversion of electricity to heat may have a higher than 90% efficiency. However, the TSU needs to be safe, self-contained, and reliable. Output of stored energy from a TSU may be in the form of steam. The steam output may then be used for heating residences, may be used in industry, and may also be used for generating electricity. For example, electricity may be used to generate heat in the TSU, where the TSU acts as a heat reservoir or “battery” for storing the heat for later conversion of the thermal energy to electrical energy using a steam turbine. The steam may also be used for sterilization, cleaning, as a motive power, and to heat water.

Multiple TSUs may share a common steam engine/turbine/generator set. These TSUs may be suitable for supplying power at peak times. A TSU may directly store waste heat from manufacturing processes and internal combustion engines. Additionally, it may be possible to use a TSU to heat commercially available thermal transfer fluids instead of steam. A thermal transfer fluid may transfer heat to an external heat exchanger which may provide a heat source for other uses. Heat from a TSU may also be used to drive a heat engine such as a Sterling engine without the need for steam.

Additionally, when storing energy in a material such as sand, rock, concrete or similar materials, the critical factor may be the thermal transfer rates of the materials. These materials may have some of the lowest transfer rates and transferring energy through the materials may be difficult. Accordingly, there is still a need for a TSU that greatly enhances thermal transfer rates thereby greatly increasing the efficiency of the TSU making it smaller, less expensive and simpler to operate and maintain.

### SUMMARY

In concordance with the present disclosure, a TSU that greatly enhances thermal transfer rates thereby greatly increasing the efficiency of the TSU, making it smaller, less expensive, and simpler to operate and maintain, is surprisingly discovered.

Embodiments of the present technology include a TSU for storing electrical energy in the form of thermal energy. The TSU may include a main body consisting of an insulated chamber with airtight walls and floor, and a steam system disposed within the main body. The steam system may include water injection. A pressurized plenum may include apertures and be pressurized with a fluid substance, such as air, where the pressurized fluid passes through holes in a plate to form a fluidized bed of a solid particulate. The chamber may be filled with an appropriate size and amount of the solid particulate, such as sand. In certain embodiments, the steam system may be a sealed closed loop unit. The TSU may convert electrical power to thermal energy for storage, convert the stored heat into steam for external use or transfer the heat via thermal conduit to the outside to power an external device, and/or be used for power generation, industrial heating, and residential heating.

In certain embodiments, a TSU may include a chamber having a predetermined amount of solid particulate. A chamber inlet may be in fluid communication with a pressurized fluid. A chamber outlet may be configured to allow the pressurized fluid to exit the chamber. The chamber may include a vertical dimension that may be greater than a horizontal dimension. The chamber may also include a top end and a bottom end relative to the vertical dimension, the chamber inlet located proximate the bottom end and the chamber outlet located proximate the top end.

A plenum may be disposed between the chamber inlet and the chamber outlet, the plenum configured to pass the pressurized fluid from the chamber inlet to the solid particulate to form a fluidized bed of the solid particulate in the chamber prior to the pressurized fluid exiting the chamber outlet. The plenum may include a plate having a plurality of apertures configured to pass the pressurized fluid from the chamber inlet to the solid particulate to form a fluidized bed of the solid particulate. In certain embodiments, a heating element may be configured to be thermally coupled to the fluidized bed. The heating element may be configured to convert electrical energy into thermal energy and transfer the thermal energy to the fluidized bed of the solid particulate.

The heating element may include a plurality of heating elements. Each heating element may be in proximity to an exterior surface of the wall of the chamber. A tubing may be thermally coupled to the fluidized bed and include a tubing inlet and a tubing outlet. The tubing may be configured to pass a heat transfer fluid from the tubing inlet to the tubing outlet and transfer thermal energy between the heat transfer fluid and the fluidized bed of the solid particulate.

A heatable firebrick base may be disposed below the chamber. An insulating jacket may surround the chamber. The insulating jacket may be configured to support a weight of the chamber and the predetermined amount of solid particulate disposed within the chamber. An electronic controller may be in communication with a thermocouple. The thermocouple may be configured to measure a temperature representative of the chamber. The electronic controller may further be configured to control the heating element based upon the temperature representative of the chamber as measured by the thermocouple.

A method of using a thermal storage unit may include using a heating element to convert electrical energy into thermal energy and transfer the thermal energy to a fluidized bed of solid particulate. The method may further include passing the heat transfer fluid from a tubing inlet to a tubing outlet and transferring thermal energy from the fluidized bed of the solid particulate to the heat transfer fluid. The heat transfer fluid may be passed from the tubing inlet to the tubing outlet and transferring thermal energy may be transferred from the fluidized bed of the solid particulate to the heat transfer fluid.

The heating element may also be used to convert electrical energy into thermal energy and transfer the thermal energy to the fluidized bed of the solid particulate in an interior of the chamber. The heat transfer fluid may be passed from the tubing inlet to the tubing outlet and transferring the thermal energy may be transferred from the fluidized bed of the solid particulate to the heat transfer fluid.

In certain embodiments, passing the heat transfer fluid from the tubing inlet to the tubing outlet and transferring the thermal energy from the fluidized bed of the solid particulate to the heat transfer fluid produces a vaporized heat transfer fluid. In certain embodiments, electricity may be generated using a turbine powered by the vaporized heat transfer fluid.

Further areas of applicability will become apparent from the description provided herein. It should be understood that the description and specific examples are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a schematic diagram illustrating a thermal storage unit, according to an embodiment of the present disclosure.

FIGS. 2A-2C are block diagrams of thermal storage units, according to embodiments of the present disclosure.

FIG. 3 is a flowchart illustrating a method of using a thermal storage unit, according to an embodiment of the present disclosure.

### DETAILED DESCRIPTION

The following description of the technology is merely exemplary in nature of the subject matter, manufacture, and use of one or more inventions and is not intended to limit the scope, application, or uses of any specific invention claimed in this application or such other applications as may be filed claiming priority to this application, or patents issuing therefrom. Regarding methods disclosed, the order of the steps presented is exemplary in nature, and thus, the order of the steps can be different in various embodiments, including where specific steps can be simultaneously performed, unless expressly stated otherwise. “A” and “an” as used herein indicate “at least one” of the item is present; a plurality of such items may be present when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from common methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components, or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values, including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer, or section from another region, layer, or a section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations), and the spatially relative descriptors used herein are interpreted accordingly.

The present technology relates to a TSU designed to store electrical energy in the form of heat and then convert it back to electrical energy or provide steam for industrial and residential purposes. The TSU may use a Sterling heat engine or a steam engine (piston) or turbine/generator combination to convert the heat into electricity. In certain embodiments, when utilizing multiple TSUs, the TSUs may share a common steam engine or turbine/generator set. A TSU or multiple TSUs may be suitable for supplying power at peak times, such as a peaker plant and run when there is a high demand for power. Such TSUs may be located in a regional setting or within a dense urban area to meet local demands.

In addition, a TSU may be incorporated into a tall column and have a small footprint. In certain embodiments, a fluid such as pressurized air may be fed to the TSU to uniformly agitate a column of solid particulate, such as sand. In particular, the entire TSU may resemble a grain silo. A TSU designed with a small footprint may require less gas flow to agitate the bed. In certain embodiments, the fluidization gas may be recycled and recirculated via a turbocharger style pump if desired.

In certain embodiments, the TSU may contain a solid particulate such as dry sand or other appropriately desired material capable of retaining heat. In certain embodiments, dry sand within the TSU may store 0.780 kj (kilojoules) of energy per kg (kilogram) per ° C. (Celsius). For example, if there is 1600 kg of sand per cubic meter, and the sand weighs 1912.5 pounds, then in a cubic meter of sand there may be 1248 kj of energy or 0.3467 kWh ° C. In certain embodiments, at 1100° C. the sand may store 381.33 kWh of energy per cubic meter.

The fluidized bed of the TSU may include a column of the solid particulate within a tubular chamber and include a plenum on the bottom. In certain embodiments, the solid particulate may include a filtered sand of a specific composition. The plenum may be pressurized with a fluid gas and include a plurality of holes in a plate at the top of the plenum. The holes of the plenum may be drilled or burned with a laser in a pattern to bleed the fluid into the column of solid particulate. The solid particulate may agitate and move as the fluid from the plenum passes through the solid particulate. The solid particulate may churn and move about as the pressurized fluid moves through the solid particulate. This may mix the solid particulate and minimize any temperature gradient of the solid particulate as it is heated within the fluidized bed. The churning of the solid particulate may increase a thermal transfer rate as the fluidized bed is heated or as heat is extracted from the fluidized bed of solid particulate. In certain embodiments, the fluidization or agitation of the solid particulate may only occur when the chamber is being heated. The fluidization may be turned off when the solid particulate has been heated to a predetermine temperature where the heat is stored by the solid particulate.

In certain embodiments, the fluidizer plenum may be separated from a bed container and located at a bottom of the bed of the TSU. Tubing, such as steam tubing thermally coupled to the TSU, may surround the fluidized bed. The shape of the tubing may allow a thermal expansion of the tubing to add a sufficient surface area to transfer heat to the fluidized bed and the solid particulate. In particular, steam tubing may comprise an array of tubing within the TSU containing the chamber. The tubing may be configured to follow a repeating, circuitous, and/or tortuous pathway to maximize heat transfer between the tubing and the chamber containing the fluidized bed of solid particulate. The tubing may be of sufficient size to transfer heat to create adequate steam pressure and volume. The tubing may include a continuous tubing that may loop through, surround, and or travel around a back and/or through the chamber. In particular, the tubing may include any appropriately desired tubing for transferring heat and/or creating steam pressure at an appropriate volume.

In certain embodiments, one or more thermocouples may extend into the fluidized bed to monitor a thermal gradient of the solid particulate located within the bed. Based on a temperature of the solid particulate and/or a thermal gradient of the fluidized bed, an electronic controller may activate and/or deactivate a heating element to heat the solid particulate. Based on a temperature of the solid particulate, the plenum may agitate the solid particulate to fluidize and/or mix the solid particulate.

In certain embodiments, the solid particulate within the TSU may have a high melting temperature so that the solid particulate remains in a solid form during use. For example, sand may melt at 1760° C. and may indefinitely tolerate an operating range of 800° C. to 1100° C. Consequently, a chamber wall, the fluidizing plenum, and the tubing of the TSU may be made of a high temperature alloy such as an Inconel® manufactured be the Special Metals Corporation of New Hartford, New York or similar material which may tolerate similar temperatures. The TSU may further include an appropriately desired material to properly withstand heat, pressure, and chemical interactions occurring within the TSU. In certain embodiments, the tubing, the heating elements, and the other components of the TSU may be repairable, and the entire TSU may be recyclable.

The TSU may further include a fire brick floor configured to support the weight of the fluidized solid particulate bed. In particular, an insulating jacket may surround an entirety of the TSU. In certain embodiments, the insulating chamber may include a blanket and/or a firebrick wall. The firebrick wall and/or the insulating jacket may substantially or completely enclose the chamber in which the fluidized bed of solid particulate is formed. In particular, the firebrick wall and/or the firebrick floor may include a material able to withstand a high amount of heat without degrading. In certain embodiments, the firebrick floor may include a clay material and be able to insulate and retain heat within the chamber without degrading at the operating temperatures expected for the TSU.

The TSU may store heat the within the solid particulate contained within a vertically disposed chamber. In certain embodiments, the vertically disposed chamber may include a metal and/or a metal alloy. For example, in certain embodiments, the vertically disposed chamber may include a stainless-steel alloy for corrosion resistance. However, the chamber may include any appropriately desired tube and/or chamber for holding the solid particulate. A heating element for heating the solid particulate may be external to the chamber or disposed within the solid particulate. If the heating element(s) are disposed within the chamber, they need to be contained within a protective metallic well to prevent the heating element(s) from directly contacting the solid particulate. However, the heating element and/or a plurality of heating elements of the TSU may be located at any appropriately desired location for heating the solid particulate within the chamber.

The plenum may be located at a bottom of the chamber and be configured to pass a pressurized fluid gas to the solid particulate to form the fluidized bed of the solid particulate in the chamber. A plate above the plenum may include an array of apertures to allow a passage of the pressurized fluid upward into the chamber. The apertures may contain a sufficient size and a spacing to prevent the solid particulate from passing downward into the plenum. The chamber may include a removable lid that is vented to the outside of the chamber. In certain embodiments, the lid may function as a filter or retention plate to prevent the solid particulate from exiting the chamber. The lid may be further vented with a plurality of apertures. The apertures may be an appropriate size to prevent the solid particulate from exiting the chamber, especially when the fluidized bed of the solid particulate is in operation. The chamber may include a framework with sufficient strength to insulate and support the chamber and the solid particulate. The solid particulate may include any appropriately desired material capable of withstanding a high temperature and that is able to easily fluidize and float within a fluidized column.

A heating element may be external to the chamber and/or located within the chamber. The heating element may be located at any appropriately desired location for heating the solid particulate. In certain embodiments, a plurality of heating elements may include different types and include different voltages from different sources. The chamber may be various sizes and shapes as appropriately desired to contain a sufficient amount of solid particulate. One or more flanges may be welded to the chamber to attach the lid and the fluidizing chamber. The fluidizing chamber may contain a fluidizing plate including a plurality of holes to pass the fluidizing gas. The fluidizing gas may include air or another appropriately desired fluid capable of fluidizing the solid particulate located within the chamber. In particular, the solid particulate may be chosen such that it is capable of being properly fluidized and storing thermal energy.

In certain embodiments, the tubing of the TSU may include one or more inlet throttle, stainless steel tubing of sufficient length and volume to transfer energy, an outlet valve to maintain a back pressure in the system, and a pressure relief valve. The controls for providing heat transfer fluid (e.g., water) at the correct rate and temperature may be separate. A pressurized fluid source for forming the fluidized bed of solid particulate may also be configured as a contained and separate system, where the pressurized fluid gas may be preheated and recirculated if so desired.

Advantageously, one or more TSUs may be configured in physical sizes and throughputs to achieve a peak power energy storage. In this way, operation of the TSUs within maximum and minimum working temperatures can achieve appropriately desired thermal transfer rates to and from the solid particulate to provide transfer of electrical energy to thermal energy, where the thermal energy can be later transferred to electrical energy on demand or used for other purposes. Additionally, the TSU may be designed to be scalable, with an ease of maintenance, reliability, longevity, and be affordable.

Where the TSU is able to increase its heat, more energy may be stored. However, because the TSU, in accordance with the present technology, has minimal moving parts or mechanisms to agitate the solid particulate beyond the source of pressurized fluid and the heat transfer fluid, the TSU provides a durable and robust system. The components of the present technology may be easily serviceable and replaceable. In addition, the solid particulate, such as sand, located within the chamber may not leak like a liquid, but rather flow to an angle of repose and stop. Where steam is created, the steam may carry as much as two and a half times the amount of energy as air for providing power to a turbine. Moreover, steam may not impact the system as water would, because the steam remains a vapor and does not solidify within the system. The TSU may also add heat and remove heat simultaneously, so that energy may be produced even when heat may be extracted. In certain embodiments, the TSU may encompass a closed loop so that any pressurized fluid (e.g., pressurized air) may be recycled and recirculated and need not be a point of energy loss. Additionally, the solid particulate, such as sand, within the chamber is fluidized so that it less abrasive. Moreover, the TSU may not emit any harmful gases or other pollution.

Example embodiments of the present technology are provided with reference to the several figures enclosed herewith.

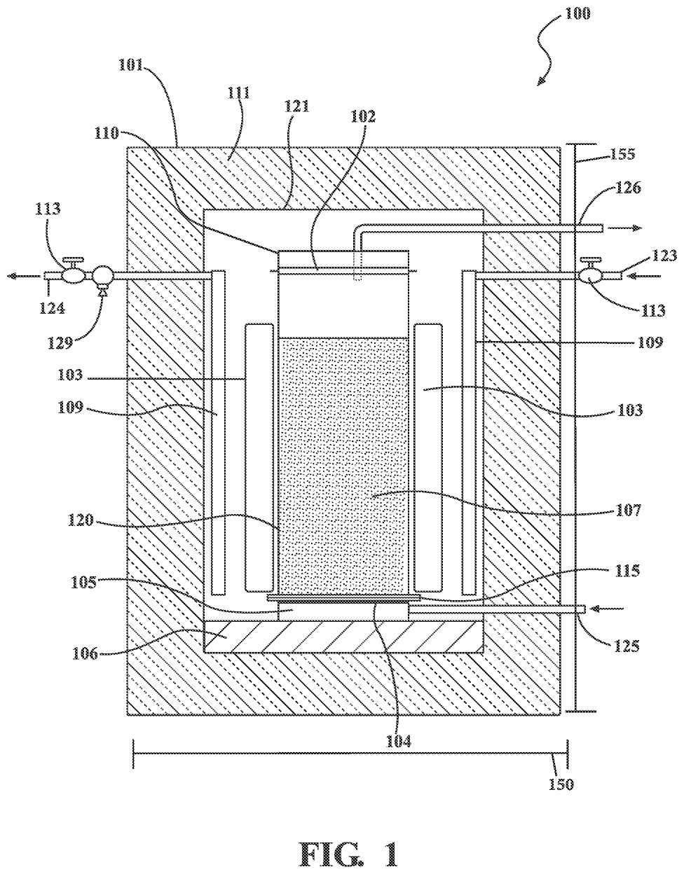

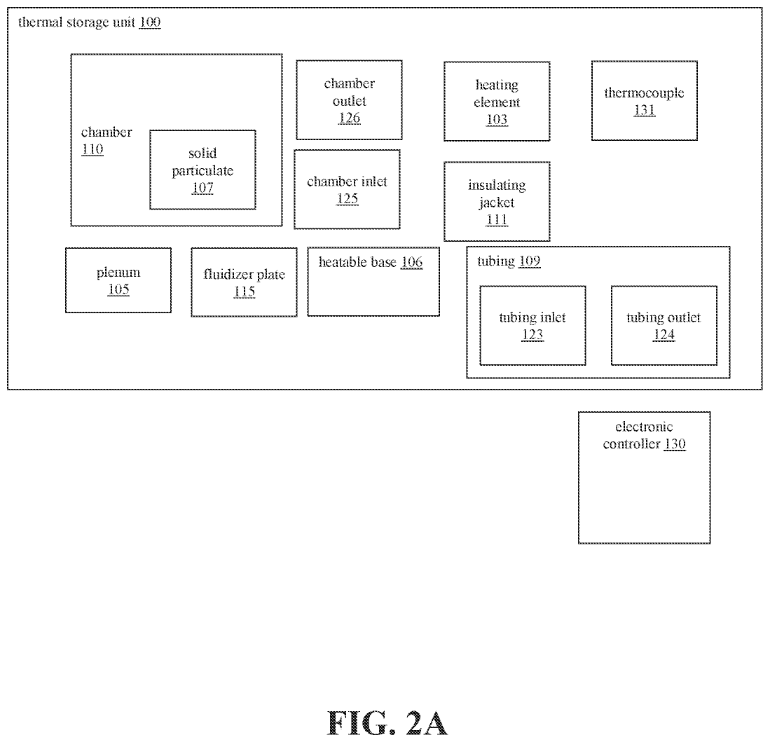

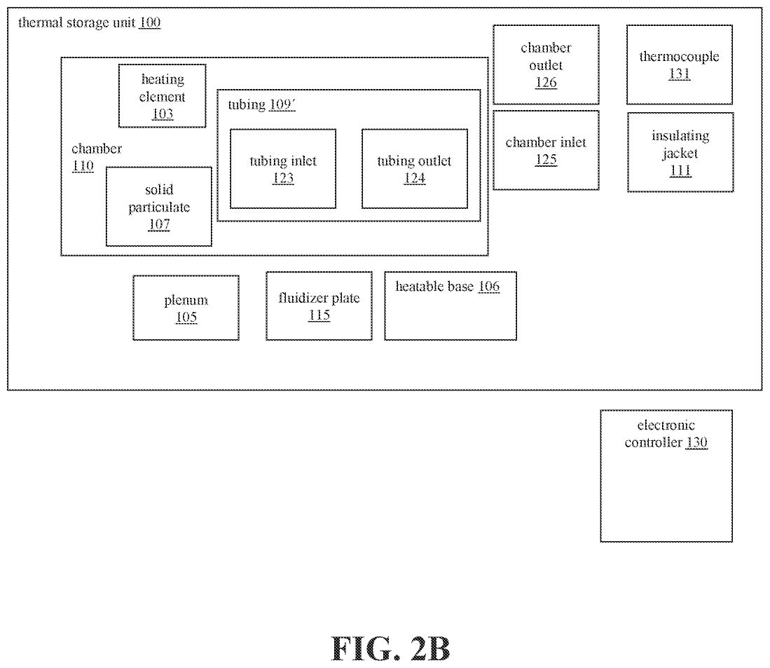

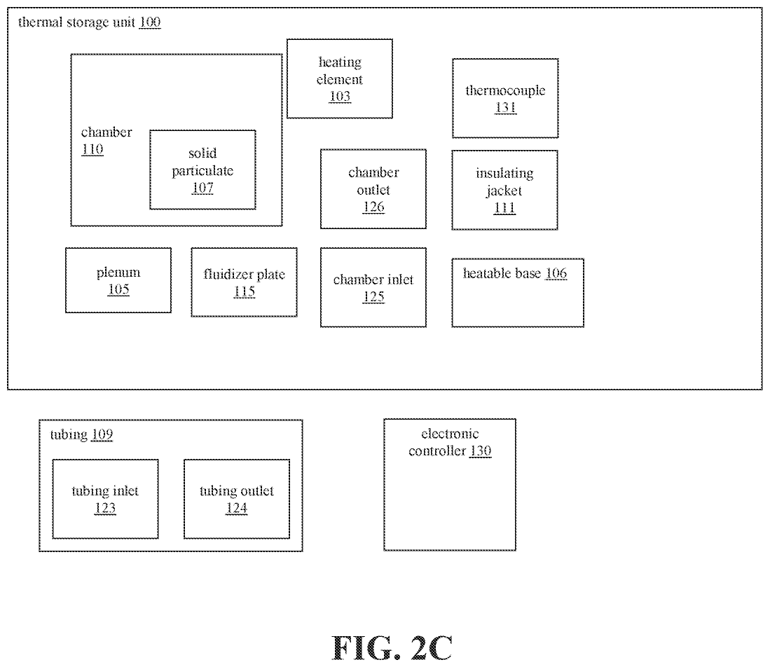

FIGS. 1, 2A, 2B, and 2C show embodiments of a TSU 100. The TSU 100 may include a chamber 110. The chamber 110 may include a plurality of chamber walls 120 and a floor. In certain embodiments, the chamber 110 may be located on a heatable base 106. For example, the heatable base 106 may include a firebrick base. In certain embodiments, the TSU 100 may be disposed in a vertical orientation. The TSU 100 may further include a removable lid 102 disposed at a top of the chamber 110. The removable lid 102 may be vented to an exterior of the chamber 110. An insulating jacket 111 may surround the chamber 110. In certain embodiments, the insulating jacket 111 may be configured to support a weight of the chamber 110 and the predetermined amount of solid particulate 107 disposed within the chamber 110. The insulating jacket 111 may include an inner wall 121 and an outer wall 101 that surrounds the chamber 110. In certain embodiments, a vertical dimension 155 may be greater than a horizontal dimension 150 of the chamber 110.

The chamber 110 may be configured to hold a predetermined amount of solid particulate 107. As described above, in certain embodiments, the solid particulate 107 may include a sand or silica material. However, the solid particulate 107 may include any appropriately desired material capable of storing thermal energy. A chamber inlet 125 may be in fluid communication with a pressurized fluid, such as air. A chamber outlet 126 may allow the pressurized fluid to exit the chamber 110. The TSU 100 may also include a plenum 105 or fluidizer disposed between the chamber inlet 125 and the chamber outlet 126. In certain embodiments, the plenum 105 may pass the pressurized fluid from the chamber inlet 125 to the solid particulate 107 to form a fluidized bed of the solid particulate 107 in the chamber 110 prior to the pressurized fluid exiting the chamber outlet 126. A fluidizer plate 115 may be disposed above the plenum 105. The fluidizer plate 115 may include an array of holes that allow the pressurized fluid to flow upward into the chamber 110 to agitate the solid particulate 107. The holes may be small enough to prevent the solid particulate 107 from passing downward into the plenum 105. The TSU may further include a seal 104 between plenum 105 and the chamber 110.

The TSU 100 may also include a heating element 103 configured to be thermally coupled to the fluidized bed of the solid particulate 107 in the chamber 110. The heating element 103 may convert electrical energy into thermal energy and transfer the thermal energy to the fluidized bed of the solid particulate 107. The heating element 103 may also be disposed proximate the chamber 110 to transfer thermal energy to the chamber 110. The heating element 103 may also be disposed at an intermediate position between the chamber 110 and the insulating jacket 111. Heating of the chamber 110 by the heating element 103 therefore transfers thermal energy to the fluidized bed of the solid particulate 107 formed in the chamber 110.

Heat transfer fluid may be passed through and/or recirculated through the TSU 100 using tubing 109. Tubing 109 may be thermally coupled to the chamber 110 and the fluidized bed of the solid particulate 107 in the chamber 110. In certain embodiments, the tubing 109 may comprise steam tubing. However, the tubing 109 may be configured to transport any appropriately desired fluid. The tubing 109 may include a tubing inlet 123 and a tubing outlet 124. The tubing 109 may be configured to pass a heat transfer fluid from the tubing inlet 123 to the tubing outlet 124 and transfer thermal energy between the heat transfer fluid and the fluidized bed of the solid particulate 107. In certain embodiments, the heat transfer fluid may include an appropriately desired fluid for transferring heat, such as steam and/or water.

In certain embodiments, the tubing inlet 123 may be configured to transfer an amount of water across the fluidized bed and output steam from the tubing outlet 124. The tubing 109 may be located within one or more hot zones of the TSU. Alternatively, the tubing 109 may be located directly within the fluidized bed of solid particulate 107. In particular, where tubing 109 is located within a hot zone of the TSU, the tubing 109 may receive and transfer heat by radiation, and where the tubing 109 is located with the fluidized bed of solid particulate 107 the tubing 109 may be heated by conduction. The tubing 109 may include one or more fluid valves 113 and pressure release valves 129 as appropriately desired. In certain embodiments, the tubing 109 may include a steam system including an inlet throttle, stainless steel tubing of sufficient length and volume to transfer energy, an outlet valve to pass steam while maintaining a back pressure in the system, and a pressure relief valve 129. In certain embodiments, the tubing 109 may include a closed loop system configured to recirculate and/or reuse the heat transfer fluid.

As shown within FIGS. 2A-2B, the tubing 109, 109′ may be located outside the chamber 110 and/or inside of the chamber 110. When the tubing 109 is located outside the chamber 110, as shown in FIG. 2A, the tubing 109 can be positioned about the chamber 110, in direct contact with the chamber 110, and/or in an intermediate space between the chamber 110 and the insulating jacket 111. An example of the tubing 109 located at an intermediate space between the chamber 110 and the insulating jacket 111 is shown in FIG. 1.

As shown in FIG. 2C, certain embodiments include where the heating element 116 may be disposed proximate an exterior of a chamber wall 120 of the chamber 110. The heating element 103 may include a plurality of heating elements 103. Each heating element 103 may be disposed proximate the exterior of the chamber wall 120 of the chamber 110. As shown in FIGS. 2A-2C, the heating element 103 may be located proximate to chamber 110, close to a wall of the chamber 110, and close to the chamber 110, but not in direct contact with the chamber 110. In particular, the heating element 103 may be located in any appropriately desired location for heating the chamber 110 and the fluidized bed of solid particulate 107 within the chamber 110.

The TSU 100 may further include an electronic controller 130 in communication with a thermocouple 131. One or more thermocouples 131 of the TSU may be configured to monitor a temperature inside the TSU. The electronic controller 130 may be configured to control temperature and power to the heating element 103. For example, the thermocouple 131 may be configured to transmit a signal representative of the internal temperature of the chamber 110 to the electronic controller 130, and the electronic controller 130 may be configured to deactivate the heating element 103 upon the internal temperature exceeding a predetermined temperature. In certain embodiments, once the internal temperature no longer exceeds the predetermined temperature, the controller is configured to activate the heating element to heat the chamber.

In certain embodiments, the heating element 103 may be used to convert electrical energy into thermal energy and transfer the thermal energy to the fluidized bed of the solid particulate 107. The heat transfer fluid may be passed from the tubing inlet 123 to the tubing outlet 124 such that thermal energy from the heat transfer fluid may be transferred to the fluidized bed of the solid particulate. The heat transfer fluid may be passed passing the heat transfer fluid from the tubing inlet 123 to the tubing outlet 124 and thermal energy may be transferred from the fluidized bed of the solid particulate 107 to the heat transfer fluid.

A method of using a TSU may include using the heating element 103 to convert electrical energy into thermal energy and transfer the thermal energy to the fluidized bed of the solid particulate 107. The method may also include passing the heat transfer fluid from the tubing inlet 123 to the tubing outlet 124 and transferring thermal energy from the heat transfer fluid to the fluidized bed of the solid particulate 107. The method may further include passing the heat transfer fluid from the tubing inlet 123 to the tubing outlet 124 and transferring thermal energy from the fluidized bed of the solid particulate 107 to the heat transfer fluid.

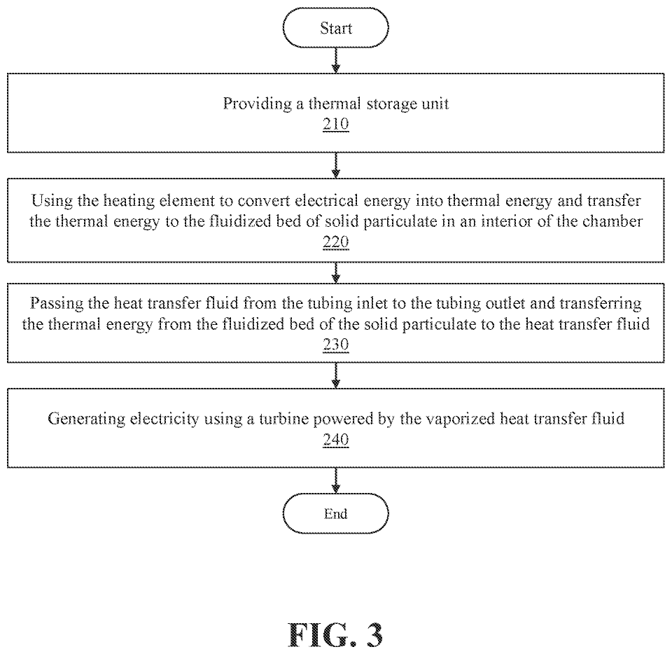

FIG. 3 is a flowchart that describes a method of using a TSU. In certain embodiments, at step 210, a TSU 100 may be provided. The TSU 100 may include a TSU 100, such as described above. In step 220, a heating element 103 may be used to convert electrical energy into thermal energy and transfer the thermal energy to a fluidized bed of solid particulate 107 in an interior of the chamber 110. In step 230, the heat transfer fluid may be passed from the tubing inlet 123 to the tubing outlet 124 and thermal energy may be transferred from the fluidized bed of the solid particulate 107 to the heat transfer fluid. Passing the heat transfer fluid from the tubing inlet 123 to the tubing outlet 124 and transferring the thermal energy from the fluidized bed of the solid particulate 107 to the heat transfer fluid may produce a vaporized heat transfer fluid. Then, in certain embodiments, in step 240, electricity may be generated using a turbine, such as a steam turbine powered by the heat transfer fluid.

Example embodiments are provided so that this disclosure will be thorough and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications, and variations of some embodiments, materials, compositions, and methods can be made within the scope of the present technology, with substantially similar results.

What is claimed is:

1. A thermal storage unit, comprising:
a chamber including:
a predetermined amount of solid particulate;
a chamber inlet configured to be in fluid communication with a pressurized fluid gas;
a chamber outlet configured to allow the pressurized fluid gas to exit the chamber;
a plenum disposed between the chamber inlet and the chamber outlet, the plenum configured to pass the pressurized fluid gas from the chamber inlet to the solid particulate to form a fluidized bed of the solid particulate in the chamber prior to the pressurized fluid gas exiting the chamber outlet;
a heating element configured to be thermally coupled to the fluidized bed, the heating element configured to convert electrical energy into thermal energy and transfer the thermal energy to the fluidized bed of the solid particulate; and
a tubing configured to be thermally coupled to the fluidized bed, the tubing including a tubing inlet and a tubing outlet, the tubing configured to pass a heat transfer fluid from the tubing inlet to the tubing outlet and transfer thermal energy between the heat transfer fluid and the fluidized bed of the solid particulate.

2. The thermal storage unit of claim 1, including a heatable base disposed below the chamber.

3. The thermal storage unit of claim 2, wherein the heatable base comprises a firebrick base.

4. The thermal storage unit of claim 3, further comprising an insulating jacket surrounding the chamber, the insulating jacket configured to support a weight of the chamber and the predetermined amount of solid particulate disposed within the chamber.

5. The thermal storage unit of claim 1, wherein the plenum includes a plate having a plurality of apertures configured to pass the pressurized fluid gas from the chamber inlet to the solid particulate to form a fluidized bed of the solid particulate.

6. The thermal storage unit of claim 1, wherein the pressurized fluid includes pressurized air.

7. The thermal storage unit of claim 1, wherein the tubing is disposed within the chamber.

8. The thermal storage unit of claim 1, wherein the tubing is disposed outside the chamber.

9. The thermal storage unit of claim 1, wherein the tubing is disposed around the chamber.

10. The thermal storage unit of claim 1, wherein the heating element is proximate a wall of the chamber.

11. The thermal storage unit of claim 10, wherein the heating element comprises a plurality of heating elements, wherein each heating element is proximate an exterior surface of the wall of the chamber.

12. The thermal storage unit of claim 1, further comprising an electronic controller in communication with a thermocouple, the thermocouple configured to measure a temperature representative of the chamber, the electronic controller configured to control the heating element based upon the temperature representative of the chamber as measured by the thermocouple.

13. The thermal storage unit of claim 1, wherein the chamber includes a vertical dimension that is greater than a horizontal dimension, the chamber including a top end and a bottom end relative to the vertical dimension, the chamber inlet located proximate the bottom end and the chamber outlet located proximate the top end.

14. The thermal storage unit of claim 12, further comprising a removable lid disposed within the chamber and proximate a top end of the chamber.

15. The thermal storage unit of claim 14, wherein the removable lid is vented to the chamber outlet.

16. The thermal storage unit of claim 1, wherein the solid particulate includes sand.

17. A method of using a thermal storage unit according to claim 1, the method comprising a member selected from a group consisting of:
passing the pressurized fluid gas from the chamber inlet to the solid particulate to form the fluidized bed of the solid particulate in the chamber;
using the heating element to convert electrical energy into thermal energy and transfer the thermal energy to the fluidized bed of the solid particulate;
passing the heat transfer fluid from the tubing inlet to the tubing outlet and transferring thermal energy from the fluidized bed of the solid particulate to the heat transfer fluid; and
passing the heat transfer fluid from the tubing inlet to the tubing outlet and transferring thermal energy from the fluidized bed of the solid particulate to the heat transfer fluid.

18. A method of using a thermal storage unit according to claim 1, the method comprising:
passing the pressurized fluid gas from the chamber inlet to the solid particulate to form a fluidized bed of the solid particulate in the chamber;
using the heating element to convert electrical energy into thermal energy and transfer the thermal energy to the fluidized bed of the solid particulate in an interior of the chamber; and
passing the heat transfer fluid from the tubing inlet to the tubing outlet and transferring the thermal energy from the fluidized bed of the solid particulate to the heat transfer fluid.

19. The method of using a thermal storage unit according to claim 18, wherein:
passing the heat transfer fluid from the tubing inlet to the tubing outlet and transferring the thermal energy from the fluidized bed of the solid particulate to the heat transfer fluid produces a vaporized heat transfer fluid; and
the method further comprises generating electricity using a turbine powered by the vaporized heat transfer fluid.

20. A thermal storage unit, comprising:
a chamber including:
a predetermined amount of solid particulate;
a chamber inlet configured to be in fluid communication with a pressurized fluid gas;
a chamber outlet configured to allow the pressurized fluid gas to exit the chamber,
wherein the chamber includes a vertical dimension that is greater than a horizontal dimension, the chamber including a top end and a bottom end relative to the vertical dimension, the chamber inlet located proximate the bottom end and the chamber outlet located proximate the top end;
a plenum disposed between the chamber inlet and the chamber outlet, the plenum configured to pass the pressurized fluid gas from the chamber inlet to the solid particulate to form a fluidized bed of the solid particulate in the chamber prior to the pressurized fluid exiting the chamber outlet, wherein the plenum includes a plate having a plurality of apertures configured to pass the pressurized fluid from the chamber inlet to the solid particulate to form a fluidized bed of the solid particulate;
a heating element configured to be thermally coupled to the fluidized bed, the heating element configured to convert electrical energy into thermal energy and transfer the thermal energy to the fluidized bed of the solid particulate, wherein the heating element comprises a plurality of heating elements, wherein each heating element is proximate an exterior surface of a wall of the chamber;
a tubing configured to be thermally coupled to the fluidized bed, the tubing including a tubing inlet and a tubing outlet, the tubing configured to pass a heat transfer fluid from the tubing inlet to the tubing outlet and transfer thermal energy between the heat transfer fluid and the fluidized bed of the solid particulate;
a heatable firebrick base disposed below the chamber;
an insulating jacket surrounding the chamber, the insulating jacket configured to support a weight of the chamber and the predetermined amount of solid particulate disposed within the chamber; and
an electronic controller in communication with a thermocouple, the thermocouple configured to measure a temperature representative of the chamber, the electronic controller configured to control the heating element based upon the temperature representative of the chamber as measured by the thermocouple.
